(19) United States
(12) Patent Application Publication
(10) Pub. No.: US 2022/0239192 A1
(43) Pub. Date: Jul. 28, 2022

(54) VARIABLE-FREQUENCY GENERATOR SET INTEGRATED SYSTEM DRIVEN BY INTERNAL COMBUSTION ENGINE

(71) Applicant: Chongqing Lihua Automation Technology Co., Ltd., Chongqing (CN)

(72) Inventors: Lin He, Chongqing (CN); Yongdong Qiu, Chongqing (CN); Bin Chen, Chongqing (CN)

(21) Appl. No.: 17/579,614

(22) Filed: Jan. 20, 2022

(30) Foreign Application Priority Data
Jan. 25, 2021 (CN) 202110096598.9

(51) Int. Cl. H02K 7/18; H02K 1/17; H02K 1/27

(52) U.S. Cl. CPC H02K 7/1815; H02K 1/27; H02K 1/17

(57) ABSTRACT

A variable-frequency generator set integrated system driven by an internal combustion engine includes a permanent magnet generator and an inverter device. The winding coils on the permanent magnet generator stator are all three-phase winding coils. The inverter device has an AC-DC rectification and voltage stabilization unit, a DC-AC variable-frequency inverter unit, a DC-DC conversion unit, and a control unit. The AC-DC rectification and voltage stabilization unit has an input end, a first output end, and a second output end respectively connected with the three-phase winding coils, the DC-AC variable-frequency inverter unit, and the DC-DC conversion unit. The DC-DC conversion unit is configured to convert a DC power source rectified by the AC-DC rectification and stabilization unit to a plurality of DC power sources with different voltages to supply power to the control unit and directly output. The permanent magnet generator is smaller in volume and weight and lower in cost.

### FIELD OF THE INVENTION

The present invention relates to the technical field of variable-frequency generator set driven by an internal combustion engine, and more particularly to a variable-frequency generator set integrated system driven by an internal combustion engine.

### BACKGROUND OF THE INVENTION

FIG. 4 is a block diagram for illustrating the principle of a variable-frequency generator set integrated system driven by an internal combustion engine according to the prior art. FIG. 5 is a structural schematic diagram of winding coils of each pole winding groove of a permanent magnet generator stator according to the prior art. Please refer to FIGS. 4 and 5. The existing variable-frequency generator set driven by an internal combustion engine is matched with a permanent magnet generator, a DC12V output power source, an igniter system, and an inverter device. The DC12V output power source requires the permanent magnet generator independent direct current (DC) power supply winding coil 11 to provide energy (100 W), the igniter system requires the permanent magnet generator independent ignition power supply winding coil 12 to provide a working power source (5-10 W), and the inverter device requires the permanent magnet generator independent inverter power supply winding coil 13 to provide a working power source (5-10 W). That is, in the prior art, three independent auxiliary power source winding coils need to be set on the permanent magnet stator generator to provide working power sources to the DC12V output, the igniter system and the inverter device respectively.

However, the inventor of the present invention have discovered through research that the existing permanent magnet generator stator has a large number of independent winding coils due to that three independent auxiliary power supply winding coils need to be installed on the permanent magnet generator stator to provide a power source for the DC12V output power source and provide a working power source for the igniter system and the inverter device. Thus, the existing permanent magnet generator stator has a complicated production process during winding, the power generation of the permanent magnet generator stator three-phase winding coils 14 cannot be used effectively, so the utilization rate of the power density of the permanent magnet generator is low.

### SUMMARY OF THE INVENTION

In the existing problem of the permanent magnet generator stator, three independent auxiliary power winding coils need to be set to provide power sources for the DC12V output, the igniter system and the inverter device, so that the number of independent winding coils on the permanent magnet generator stator is relatively large. As a result, the permanent magnet generator stator winding production process is complicated, and the power generation of the permanent magnet generator stator three-phase power supply winding coils cannot be effectively used. Thus, the utilization rate of the power density of the permanent magnet generator is low. The present invention provides a variable-frequency generator set integrated system driven by an internal combustion engine.

In order to solve the above technical problems, the present invention adopts the following technical solutions.

A variable-frequency generator set integrated system driven by an internal combustion engine includes a permanent magnet generator and an inverter device. The permanent magnet generator has a permanent magnet generator stator and a permanent magnet generator rotor arranged in a clearance fit. The winding coils on the magnet generator stator are all three-phase winding coils, and the inverter device has an AC-DC rectification and voltage stabilization unit, a DC-AC variable-frequency inverter unit, a DC-DC conversion unit, and a control unit. The input end of the AC-DC rectification and voltage stabilization unit is connected to the three-phase winding coils of the permanent magnet generator stator, the first output end of the AC-DC rectification and voltage stabilization unit is connected to the DC-AC variable-frequency inverter unit, and the DC-AC variable-frequency inverter unit is configured to invert a first DC power source rectified by the AC-DC rectification and voltage stabilization unit to output an AC. The second output end of the AC-DC rectification and voltage stabilization unit is connected to the DC-DC conversion unit, and the DC-DC conversion unit is configured to convert a second DC power source rectified by the AC-DC rectification and voltage stabilization unit to obtain a plurality of DC power sources with different voltages, and supply the plurality of DC power sources to the control units and DC output.

Furthermore, the control unit includes an inverter control unit, a throttle control unit, a choke control unit, and an igniter control unit, and the DC-DC conversion unit is configured to convert the second DC power source rectified by the AC-DC rectification and voltage stabilization unit to obtain four DC power sources with different voltage to the corresponding control units, respectively.

Compared with the prior art, the variable-frequency generator set integrated system driven by an internal combustion engine provided by the present invention eliminates other independent power supply winding coils from the three-phase winding coils by setting all the winding coils on the permanent magnet generator stator to three-phase winding coils. That is, there are no independent auxiliary power supply winding coils on the permanent magnet generator stator, which simplifies the winding production process of the permanent magnet generator stator, thereby greatly improving the production efficiency. Since the winding coils of the permanent magnet generator stator are all three-phase windings, the power generation has been greatly increased without changing the volume of the permanent magnet generator and adding additional costs, and the utilization rate of the power density of the permanent magnet generator is improved. Thus, the permanent magnet generator with the same power generation is smaller in volume and lighter in weight. That is, the weight and the volume of the generator system and generator set system are reduced, thereby reducing the system cost. At the same time, the required power is generated by the three-phase winding coils of the permanent magnet generator. The three-phase winding coils of the permanent magnet generator generate a three-phase AC. The AC is rectified by the AC-DC rectification and voltage stabilization unit and then converted by the DC-DC conversion unit to obtain a plurality of DC power sources with different voltages. The plurality of DC power sources provide a working power source for an inverter control unit, a throttle control unit, a choke control unit, and an igniter control unit, and directly output a DC12V DC power. Therefore, the present invention realizes that there are only three-phase winding coils on the permanent magnet generator stator, and no auxiliary power source winding coils.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram for illustrating the principle of a variable-frequency generator set integrated system driven by an internal combustion engine according to the present invention;

FIG. 2 is a structural schematic diagram of a configuration of a permanent magnet generator rotor and a permanent magnet generator stator according to the present invention;

FIG. 3 is a structural schematic diagram of winding coils of each pole winding groove of a permanent magnet generator stator according to the present invention;

FIG. 4 is a block diagram for illustrating the principle of a variable-frequency generator set integrated system driven by an internal combustion engine according to the prior art;

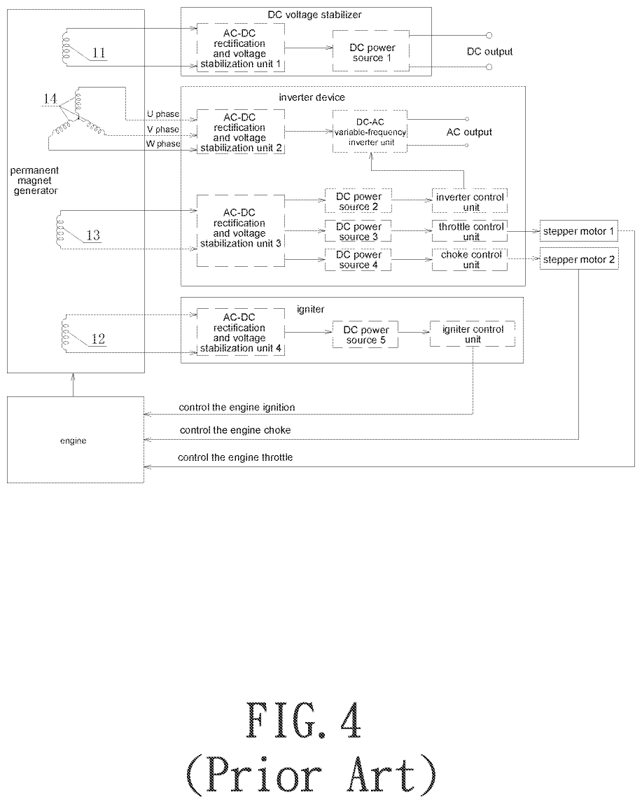

FIG. 5 is a structural schematic diagram of winding coils of each pole winding groove of a permanent magnet generator stator according to the prior art;

In the figures, 11: DC power supply winding coil; 12: ignition power supply winding coil; 13: inverter power supply winding coil; 14: three-phase winding coils; 20: permanent magnet generator stator; 30: permanent magnet generator rotor.

### DETAILED DESCRIPTION OF PREFERRED EMBODIMENTS

In order to make it easy to understand the technical means, creative features, goals, and effects achieved by the present invention, the present invention will be further explained below in conjunction with specific diagrams.

In the description of the present invention, it should be understood that the orientation or positional relationship indicated by the terms “longitudinal”, “radial”, “length”, “width”, “thickness”, “upper”, “lower”, “front”, “rear”, “left”, “right”, “vertical”, “horizontal”, “top”, “bottom”, “inner”, “outer”, etc. are the orientation or positional relationship based on what is shown on the drawings. The terms are only for the convenience of describing the present invention and simplifying the description, rather than indicating or implying that the device or element must have a specific orientation or be constructed and operated in a specific orientation. Therefore, the terms cannot be understood as a limitation of the present invention. In the description of the present invention, “plurality” means two or more unless otherwise stated.

In the description of the present invention, it should be noted that the terms “installed”, linked”, and “connected” should be understood in a broad comprehension unless there is an otherwise clear statement and limitation. For example, they can be fixed connected, detachable connected, or integrally connected. It can be a mechanical connection, an electrical connection, a direct connection, or an indirect connection. It can be connected through an intermediate medium, or it can be the internal communication between two components. For those of ordinary skill in the art, the specific meaning of the above-mentioned terms in the present invention can be understood in specific situations.

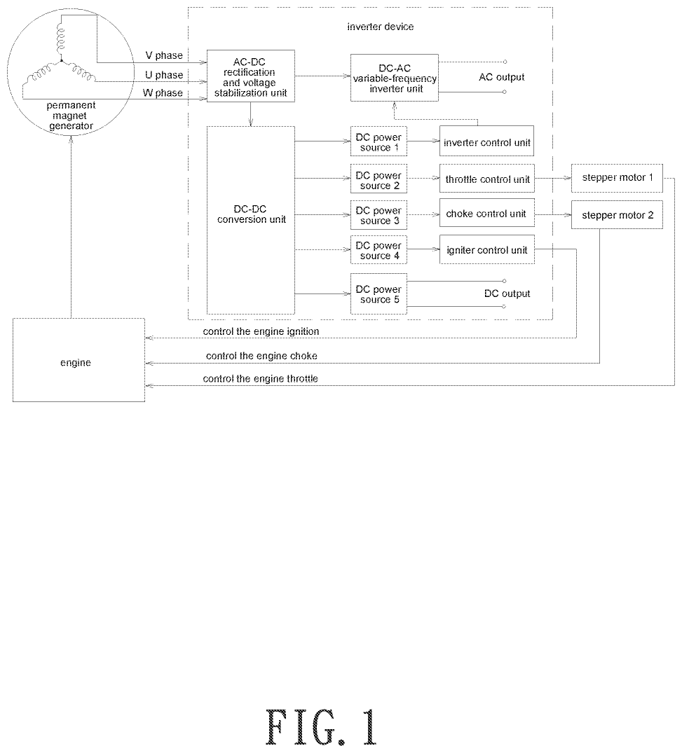

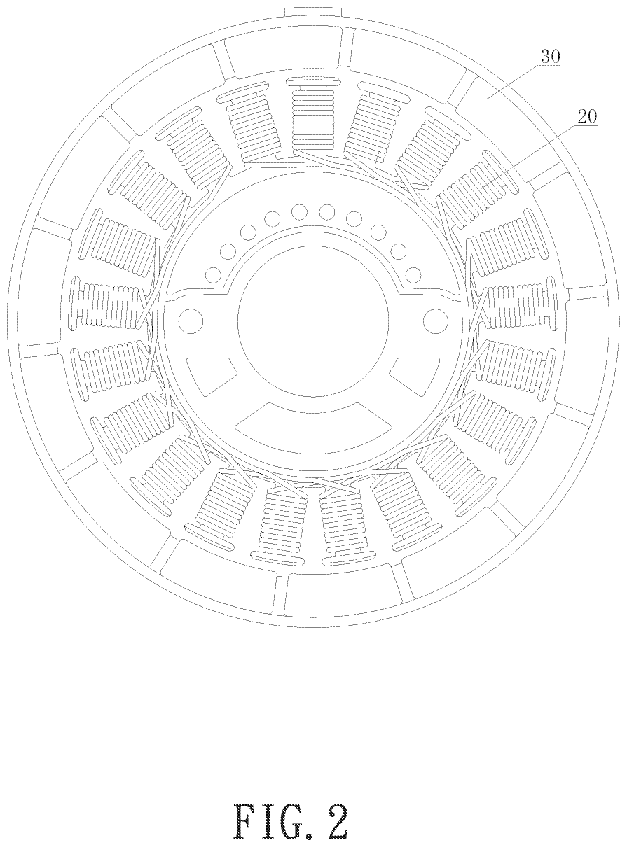

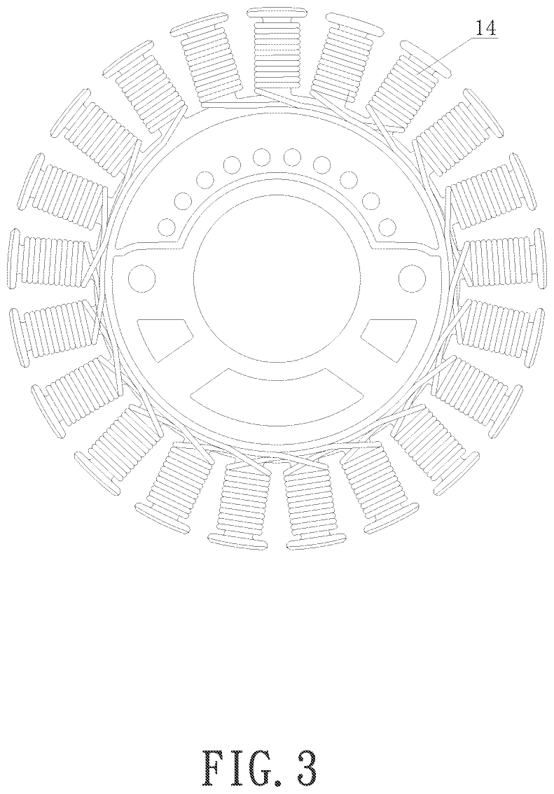

FIG. 1 is a block diagram for illustrating the principle of a variable-frequency generator set integrated system driven by an internal combustion engine according to the present invention. FIG. 2 is a structural schematic diagram of a configuration of a permanent magnet generator rotor and a permanent magnet generator stator according to the present invention. FIG. 3 is a structural schematic diagram of winding coils of each pole winding groove of a permanent magnet generator stator according to the present invention. Please refer to FIGS. 1 to 3. The present invention provides a variable-frequency generator set integrated system driven by an internal combustion engine. The variable-frequency generator set integrated system includes a permanent magnet generator and an inverter device. The permanent magnet generator includes a permanent magnet generator stator 20 and a permanent magnet generator rotor 30 arranged in a clearance fit. The winding coils on the permanent magnet generator stator 20 are all three-phase (U phase, V phase, W phase) winding coils 14. The inverter device includes an AC-DC rectification and voltage stabilization unit, a DC-AC variable-frequency inverter unit, a DC-DC conversion unit, and a control unit. The input end of the AC-DC rectification and voltage stabilization unit is connected to the three-phase winding coils of the permanent magnet generator stator 20, and the first output end of the AC-DC rectification and voltage stabilization unit is connected to the DC-AC variable-frequency inverter unit. The DC-AC variable-frequency inverter unit is configured to invert the first DC power source rectified by the AC-DC rectification and voltage stabilization unit to output an AC power (AC output). The second output end of the AC-DC rectification and voltage stabilization unit is connected to the DC-DC conversion unit. The DC-DC conversion unit is configured to convert the second DC power source rectified by the AC-DC rectification and voltage stabilization unit to obtain a plurality of DC power sources (e.g., DC power source 1, DC power source 2, DC power source 3, DC power source 4, and DC power source 5) with different voltages. The DC power sources are used to supply power to the control unit and directly output DC power (DC output). The AC-DC rectification and voltage stabilization unit, the DC-AC variable-frequency inverter unit, and the DC-DC conversion unit can be specifically implemented by using existing technology.

As a specific embodiment, the control unit includes an inverter control unit, a throttle control unit, a choke control unit, and an igniter control unit. The DC-DC conversion unit is configured to convert the second DC power source rectified by the AC-DC rectification and voltage stabilization unit to obtain four DC power sources with different voltages to supply power to the inverter control unit, the throttle control unit, the choke control unit, and the igniter control unit, respectively. In one embodiment, the throttle control unit is configured to control the engine throttle through the stepper motor 1, the choke control unit is configured to control the engine choke through the stepper motor 2, and the igniter control unit is configured to control the engine ignition. The inverter control unit, the throttle control unit, the choke control unit, and the igniter control unit are specifically the prior art well known by those skilled in the art, and no redundant detail is to be given herein.

Compared with the prior art, the variable-frequency generator set integrated system driven by an internal combustion engine provided by the present invention eliminates other independent power supply winding coils from the three-phase winding coils by setting all the winding coils on the permanent magnet generator stator to three-phase winding coils. That is, there is no independent auxiliary power supply winding coil on the permanent magnet generator stator, which simplifies the winding production process of the permanent magnet generator stator, thereby greatly improving the production efficiency. Because the winding coils of the permanent magnet generator stator are all three-phase windings, the power generation and the utilization rate of the power density of the permanent magnet generator is greatly increased without changing the volume of the permanent magnet generator and adding additional costs. Thus, the permanent magnet generator with the same power generation is smaller in volume and lighter in weight; that is, the weight and the volume of the generator system and the generator set system are reduced, thereby reducing the system cost. At the same time, the required power (e.g., three-phase AC power) is generated by the three-phase winding coils of the permanent magnet generator. The AC power is rectified by the AC-DC rectification and voltage stabilization unit and then converted by the DC-DC conversion unit to obtain a plurality of DC power sources with different voltages, which are then respectively provided to the inverter control unit, the throttle control unit, the choke control unit, and the igniter control unit as the working power sources. In addition, the DC-DC conversion unit also directly outputs a DC power (e.g., DC12V). Therefore, the present invention realizes that there are only three-phase winding coils on the permanent magnet generator stator, and no auxiliary power supply winding coils.

In order to better illustrate the technical effects of the present invention, the following description will be combined with practical applications.

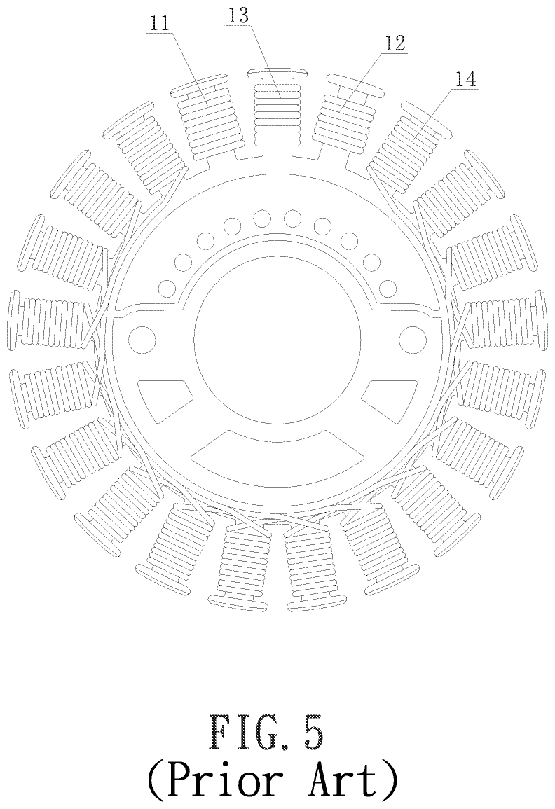

Please refer to FIGS. 2 and 5, which respectively show a permanent magnet generator of the present invention and a permanent magnet generator in prior art. Specifically, the permanent magnet generator rotors in FIGS. 2 and 5 are the same, and the permanent magnet generator stators in FIGS. 2 and 5 each have a diameter of 120 mm, a thickness of 21 mm, 21 winding poles, a speed of 4500 rpm, and a rated power of 2 KW. In FIG. 5, the existing winding method uses 18 winding poles as the three-phase winding coils 14 with an output power of 2.0 KW. The remaining three winding poles are used as the three independent AC winding coils, which are: a DC power supply winding coil 11, an ignition power supply winding coil 12, and an inverter power supply winding coils 13. Usually, three AC winding coils need to output a total power of about 120 W, and three AC winding coils can actually output more than 330 W in power. In FIG. 2, the winding method of the present invention uses all the 21 winding poles of the permanent magnet generator stator as three-phase winding coils, and the power generation can reach

$$\frac{2.0 KW}{\frac{18}{3}} * \frac{21}{3} = \frac{2.0 KW}{6} * 7 = 2.33 KW ,$$

in which the power generation is increased by about 10%. That is, the permanent magnet generator stator with the same power generation is smaller in volume and lighter in weight. Thus, the weight and the volume of the generator set system are reduced, thereby reducing the system cost.

Finally, it should be noted that the above embodiments are only used to illustrate the technical solutions of the present invention but the invention is not limited thereto. Although the present invention has been described in detail with reference to the preferred embodiments, those of ordinary skill in the art should understand that the technical solutions of the present invention can be modified or equivalently replaced without departing from the purpose and scope of the technical solution of the present invention. The modifications and replacements should be covered by the scope of the claims of the present invention.

What is claimed is:

1. A variable-frequency generator set integrated system driven by an internal combustion engine, the variable-frequency generator set integrated system comprising a permanent magnet generator and an inverter device, and the permanent magnet generator comprising a permanent magnet generator stator and a permanent magnet generator rotor arranged in a clearance fit, wherein winding coils on the permanent magnet generator stator are all three-phase winding coils, the inverter device comprises an AC-DC rectification and voltage stabilization unit, a DC-AC variable-frequency inverter unit, a DC-DC conversion unit, and a control unit, an input end of the AC-DC rectification and voltage stabilization unit is connected with the three-phase winding coils of the permanent magnet generator stator, a first output end of the AC-DC rectification and voltage stabilization unit is connected with the DC-AC variable-frequency inverter unit, the DC-AC variable-frequency inverter unit is configured to invert a first DC power source rectified by the AC-DC rectification and voltage stabilization unit to output an AC power, a second output end of the AC-DC rectification and voltage stabilization unit is connected with the DC-DC conversion unit, the DC-DC conversion unit is configured to convert a second DC power source rectified by the AC-DC rectification and stabilization unit to obtain a plurality of DC power sources with different voltages, and the plurality of DC power sources are used to supply power to the control unit and directly output DC power.

2. The variable-frequency generator set integrated system driven by the internal combustion engine according to claim 1, wherein the control unit comprises an inverter control unit, a throttle control unit, a choke control unit, and an igniter control unit, the DC-DC conversion unit is configured to convert the second DC power source rectified by the AC-DC rectification and stabilization unit to obtain four DC power sources with different voltages of the plurality of DC power sources to supply power to the inverter control unit, the throttle control unit, the choke control unit, and the igniter control unit, respectively.
